(19) United States
(12) Patent Application Publication
(10) Pub. No.: US 2015/0304703 A1
(43) Pub. Date: Oct. 22, 2015

(54) INTELLIGENT DEVICE, INTELLIGENT DEVICE CONTROL SYSTEM AND ITS IMPLEMENTATION METHOD

(71) Applicant: Sony Corporation, Tokyo (JP)

(72) Inventors: Yinghuan LIU, Shanghai (CN); Xuming HUANG, Shanghai (CN)

(73) Assignee: Sony Corporation, Tokyo (JP)

(21) Appl. No.: 14/662,393

(22) Filed: Mar. 19, 2015

(30) Foreign Application Priority Data
Apr. 21, 2014 (CN) 201410160287.4

(51) Int. Cl. H04N 21/422; H04N 21/643; H04N 21/647; H04N 21/266

(52) U.S. Cl. CPC H04N 21/42204; H04N 21/266; H04N 21/643; H04N 21/64746

(57) ABSTRACT

The application discloses an intelligent device which is either Smart TV or an intelligent peripheral connected to Smart TV. The intelligent device is used either as server side or as client side. When the intelligent device is used as server side, it includes application interface module and remote processing module. When the intelligent device is used as client side, it includes client service module. The application also discloses an intelligent device control system which includes Smart TV and at least one intelligent peripheral connected to the Smart TV; one device is used as server side, while all other devices are used as client sides. The application makes the programs and/or files of client sides integrate into the server side seamlessly, and allows user use one remote control and aim at one object, therefore operate any program and/or file of each object.

### TECHNICAL FIELD

The application relates to a transmission method of audio/video data and command data between multiple intelligent devices.

### BACKGROUND ART

The intelligent device or smart device refers to an electronic device with a control unit (such as CPU, microcontroller, control chip) on the hardware level and with an operation system on the software level. The common intelligent device includes computer, smart phone, etc.

According to the standard of intelligent device, television can be divided into two types as traditional TV and smart TV. The traditional TV can achieve a variety of functions through connecting to peripheral device. The common peripheral device includes cable TV or digital TV set-top box, local media player (such as VCR, DVD player), network media player (such as **TV box, **TV bar), game console, etc. In addition to all functions of the traditional TV, the Smart TV can install programs and store files in its operation system, thereby can achieve more functions such as surfing the web, running application or game programs, playing local or online audio/video.

According to the standard of intelligent device, the peripheral device connected to the TV can also be divided into two types as non-intelligent peripheral and intelligent peripheral. The latter is typified by some game consoles, network media players, etc.

In order to control the TV remotely, the remote control came into being. For the same purpose, some peripheral device connected to the TV also has its own remote control and maybe deformed as a game controller. When the TV connecting with the peripheral device which has independent remote control, user needs to operate the TV remote control and the peripheral remote control alternately, thus it is inconvenient for users.

One solution for using multiple remote controls at the same time is IR (Infrared Radiation) learning. It means the first remote control (such as set-top box remote control) has IR learning function; by imitating the infrared signal encode format of the frequently-used buttons of the second remote control (such as TV remote control), the first remote control learned the frequently-used buttons of the second remote control. Thus the operation of a specific button of the first remote control equals to the operation of the already learned button on the second remote control. However, this solution has two problems: firstly, IR learning between remote controls covers only part of frequently-used buttons not all buttons. Secondly, when the TV needs to be operated, the remote control needs to aim at the TV; when the peripheral device needs to be operated, the remote control needs to aim at the peripheral device; it is also inconvenient for users.

Another solution for using multiple remote controls at the same time is HDMI CEC protocol. CEC (consumer electronics control) is a non-mandatory optional content in HDMI protocol, it allows users to control all HDMI devices by one remote control among multiple HDMI CEC protocol supported HDMI devices. For example, a TV and a blu-ray player both support the HDMI CEC protocol, the blu-ray player connects to one HDMI port of the TV, and both of them in standby state. When a video disk is placed into the blu-ray player, the TV will automatically turns on because of the notification of CEC signal, then the video channel of the TV will automatically switches to the HDMI channel connected to the blu-ray player. When user turns off the TV, CEC signal will also notice all HDMI CEC protocol supported peripheral devices connected to the HDMI ports of the TV entering standby state together. However, this solution has three problems: firstly, it requires the TV and the peripheral devices all support HDMI CEC protocol. Secondly, the TV and the peripheral devices have respective user interfaces, user needs to switch back and forth between multiple user interfaces and follow menus and remote control rules under each user interface, it's difficult for user to understand. Thirdly, when the TV connects to two or more HDMI CEC protocol supported peripheral devices, the HDMI CEC protocol can only support one peripheral device automatic switching video channel and remote operation. If it needs to operate another peripheral device, the video channel needs to switch manually.

### SUMMARY OF THE INVENTION

The technical problem to be solved by the application is to provide an intelligent device; said intelligent device is used either as server side to control all other connected intelligent devices or as client side to be controlled by server side. The application also provides an intelligent device control system, which is composed of the only one server side and at least one client side. Correspondingly, the application also provides an implementation method of the intelligent device control system. When the Smart TV connects to at least one intelligent peripheral, whether or not the devices support the HDMI CEC protocol, the application allows using one remote control and aiming at one object, using one user interface to operate, no need to switch the video channel of Smart TV manually.

In order to solve the above technical problem, the intelligent device of the application is either a Smart TV or an intelligent peripheral connected to the Smart TV, said intelligent device is used either as server side or as client side;

When said intelligent device is used as server side, it includes application interface module and remote processing module; said application interface module detects and identifies each client side directly or indirectly connected to the server side, and obtains lists of all client sides' programs and/or files, and displays the server side's user interface which includes lists of both server side's and all client sides' programs and/or files; said remote processing module receives the remote control command of server side's remote control, and forwards the remote control command to the server side or client side which the remote control command targeted, and automatically switches the Smart TV's video channel to the server side or client side which the remote control command targeted, and automatically switches the Smart TV's video channel back to the server side and displays the server side's user interface when the remote control command has been executed;

When said intelligent device is used as client side, it includes client service module; said client service module responds to the detection or identification process of the server side, and collects lists of client side's programs and/or files and sends to the server side by request, and receives server side's remote control command and converts to the client side's remote control key event.

The intelligent device control system of the application includes a Smart TV and at least one intelligent peripheral connected to the Smart TV; one device of said Smart TV and intelligent peripherals is used as server side, while all other devices are used as client sides, there's transmission channel for video signal and command signal between the Smart TV and each intelligent peripheral device;

Said server side includes application interface module and remote processing module; said application interface module detects and identifies each client side directly or indirectly connected to the server side, and obtains lists of all client sides' programs and/or files, and displays the server side's user interface which includes lists of both server side's and all client sides' programs and/or files; said remote processing module receives the remote control command of server side's remote control, and forwards the remote control command to the server side or client side which the remote control command targeted, and automatically switches the Smart TV's video channel to the server side or client side which the remote control command targeted, and automatically switches the Smart TV's video channel back to the server side and displays the server side's user interface when the remote control command has been executed;

Said client side includes client service module; said client service module responds to the detection or identification process of the server side, and collects lists of the client side's programs and/or files and sends to the server side by request, and receives server side's remote control command and converts to the client side's remote control key event.

The implementation method of the intelligent device control system of the application comprises: once the server side detects and identifies the client side, and/or once the server side receives command to access the user interface, the application interface module of server side requests each client side to send their lists of programs and/or files to the server side;

Once the server side receives command to access the user interface, the application interface module of the server side displays the server side's user interface on the Smart TV's screen, said user interface includes complete lists of both server side's and all client sides' programs and/or files.

Furthermore, the implementation method of the intelligent device control system further comprises: once the server side receives the remote control command of server side's remote control, the remote processing module of server side distinguishes the object which the remote control command targeted, and forwards the remote control command to the object which the remote control command targeted. Meanwhile said remote processing module distinguishes if the Smart TV's video channel is the video channel of the object which the remote control command targeted; if yes, then the remote processing module keeps the Smart TV's current video channel; if not, then the remote processing module automatically switches the Smart TV's video channel to the object which the remote control command targeted. Furthermore when the remote control command has been executed, said remote processing module automatically switches the Smart TV's video channel back to the server side and displays the server side's user interface.

Furthermore, the implementation method of the intelligent device control system further comprises: once the client side starts, built-in client service module will run automatically as a resident service. Once the server side starts, built-in application interface module and remote processing module will run automatically as resident services. After the server side's startup, the application interface module detects and identifies each client side which has been started, and periodically updates the client sides.

The application allows user using one remote control and aiming at one object; therefore operates any program and/or file of each intelligent device, no need to switch the video channel manually, and makes data transmission between each intelligent device seamlessly.

### DESCRIPTION OF DRAWINGS

FIG. 1 to FIG. 2 are two embodiments' schematic diagrams of the intelligent device of the application.

FIG. 3 to FIG. 4 are two embodiments' schematic diagrams of the intelligent device control system of the application.

FIG. 5 to FIG. 9 are each part's flow diagrams of the implementation method of the intelligent device control system of the application.

### DESCRIPTION OF EMBODIMENTS

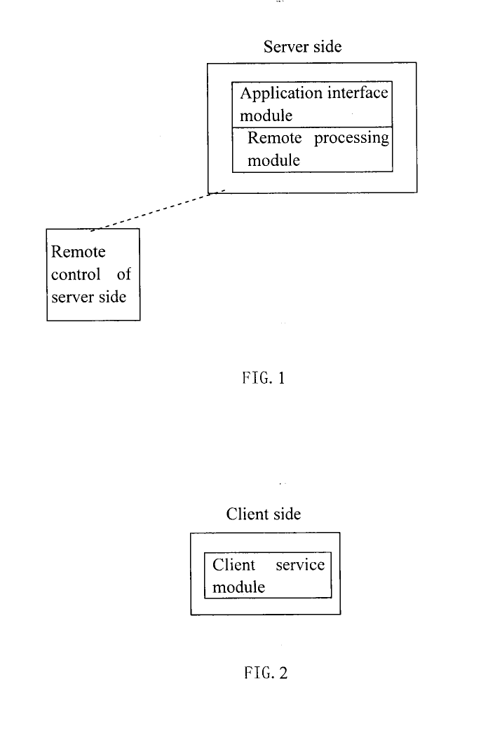

Please refer to FIG. 1, this is embodiment one of the application. The embodiment one shows the intelligent device used as the server side. Said server side is either a Smart TV or one intelligent peripheral device connected to the Smart TV. Said server side is remotely controlled by corresponding remote control. Said server side includes application interface module and remote processing module.

Said application interface module performs the following functions:

detect and identify each client side connected to the server side directly or indirectly. For example, when the server side and each client side are in the same LAN, the detection and identification is accomplished by using SSDP protocol. Said indirect connection means that when the server side directly connects to the first client side, and the first client side directly connects to the second client side, then the server side indirectly connects to the second client side. The typical use of indirect connection is: the first intelligent peripheral is used as server side, the TV and the second intelligent peripheral are used as the first and second client side respectively.

obtain lists of all client sides' programs and/or files. Said program includes two types as application and game. Said file includes text file (such as txt, doc, pdf, and other formats), audio file, video file, etc.

uniformly show the server side's user interface which includes the complete lists of both server side's and all client sides' programs and/or files.

Said remote processing module performs the following functions:

receive the remote control command of server side's remote control, and forwards the remote control command to the server side or client side which the remote control command targeted. For example, if the program or file which the remote control command targeted is on the server side (or one client side), then the object which the remote control command targeted is the server side (or said client side). For another example, if the remote control command is used to adjust the picture or sound of the Smart TV, then the object which the remote control command targeted is the Smart TV, no matter whether the Smart TV is server side or client side in the current intelligent device control system.

automatically switch the Smart TV's video channel to the server side or client side which the remote control command targeted, and automatically switch the Smart TV's video channel back to the server side and show the server side's user interface when the remote control command has been executed. Said video channel means a physical interface or data transmission way or others for transmitting video signal between the server side and the client side. When the video channel between server side and client side also transmits audio signal, then automatically switches the Smart TV's video channel including automatically switch the video signal and the audio signal. When there's independent audio channel between server side and client side, then said remote processing module also automatically switches the Smart TV's audio channel to the server side or client side which the remote control command targeted, and also automatically switches the Smart TV's audio channel back to the server side when the remote control command has been executed.

Please refer to FIG. 2, this is embodiment two of the application. The embodiment two shows an intelligent device used as the client side. Said client side is either a Smart TV or one intelligent peripheral device connected to the Smart TV. Said client side includes client service module.

Said client service module performs the following functions:

respond to the detection or identification process of the server side. For example, when the client side and server side are in the same LAN, the detection and identification is accomplished by using SSDP protocol.

collect lists of client side's programs and/or files and send to the server side by request.

receive server side's remote control command and convert to the client side's remote control key event. For example, the remote control command requires to start one program or file on one client side, then the client service module converts said remote control command to a remote control key event on said client side for start the program or file. For another example, the remote control command is used to adjust picture or sound of the Smart TV, and the Smart TV is the client side in the current intelligent device control system, then the client service module converts said remote control command to a remote control key event on the Smart TV for adjusting picture or sound.

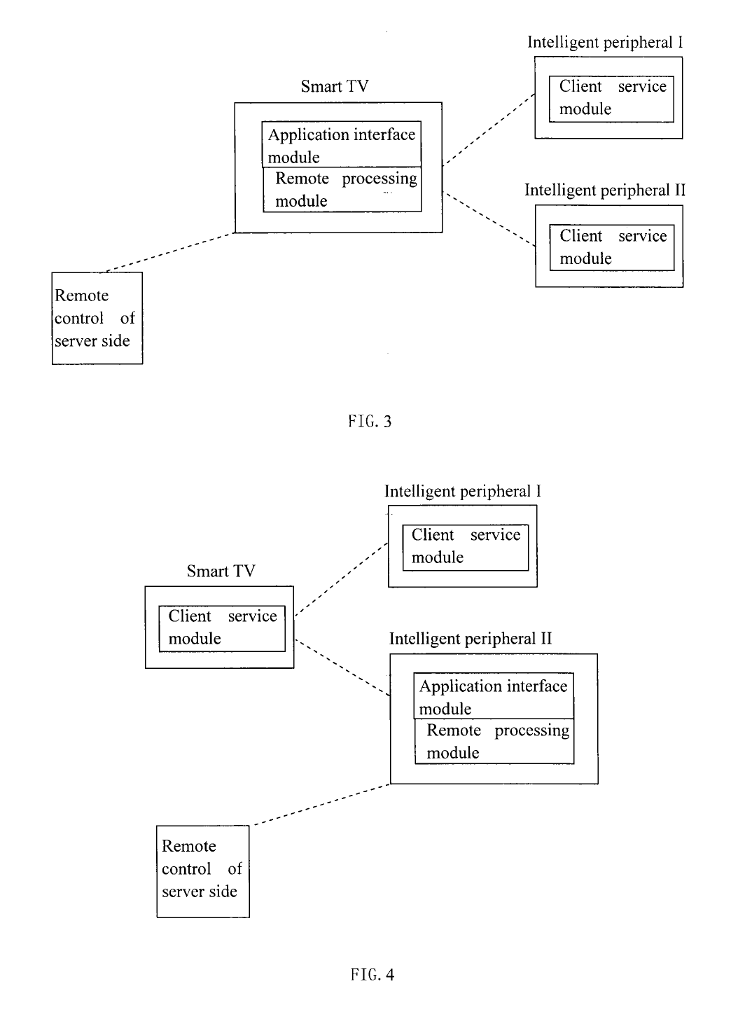

Please refer to FIG. 3, this is embodiment three of the application, and shows an intelligent device control system. Said intelligent device control system comprises one Smart TV and at least one intelligent peripheral device connected to the Smart TV. Wherein the Smart TV is used as server side, and each intelligent peripheral connected to the Smart TV is used as client side. There is data transmission channel of video signal, audio signal (optional) and command signal between each intelligent peripheral and the Smart TV. Three signals can be transmitted by the same physical interface, such as HDMI port, USB port; or by the same wired or wireless data transmission way, such as wireless network, Bluetooth, etc; or by a combination of several different physical interfaces and/or several different data transmission way.

Please refer to FIG. 4, this is embodiment four of the application, and shows an intelligent device control system. Said intelligent device control system comprises one Smart TV and at least one intelligent peripheral device connected to the Smart TV. Different from the embodiment three, one intelligent peripheral is used as server side, the Smart TV and other intelligent peripherals are used as client sides.

The implementation method of the intelligent device control system of the application comprises five parts as: the server side detects and identifies the client sides; the server side obtains lists of the programs and/or files of the client side; the server side displays the user interface; the server side forwards the remote control command of the server side's remote control; the server side automatically switches the video channel.

Please refer to FIG. 5, Once the intelligent device used as client side starts, built-in client service module will run automatically as a resident service. Once the intelligent device used as server side starts, built-in application interface module and remote processing module will run automatically as resident services. The first work after the startup of the server side is the application interface module detects and identifies each client side which has been started. This work is carried out periodically (regularly or irregularly) so as to update client sides timely which includes adding new started client side and removing closed client side.

For example, the server side is a Smart TV, and the client side is a intelligent peripheral connected to the HDMI port of the server side, then the server side can detect and identify the client side through the following methods:

Step 1, the client side obtains physical address of server side's HDMI port through HDMI protocol.

Step 2, the server side searches client side which supports SSDP protocol through the SSDP protocol.

Step 3, the client side listens to the inquiry message of SSDP protocol sent by the server side, if the inquiry message comforms to the specifications of SSDP protocol, the client side replies to the server side, the reply message includes its own IP address and the physical address of server side's HDMI port which the client side connected to.

Step 4, the server side identifies the client side which connected to the server side's HDMI port through the received physical address of HDMI port.

For another example, when the server side and the client side both support HDMI CEC protocol, then the client side sends its own IP address to the server side through Vendor command of said protocol, therefore the server side detects and identifies the client side.

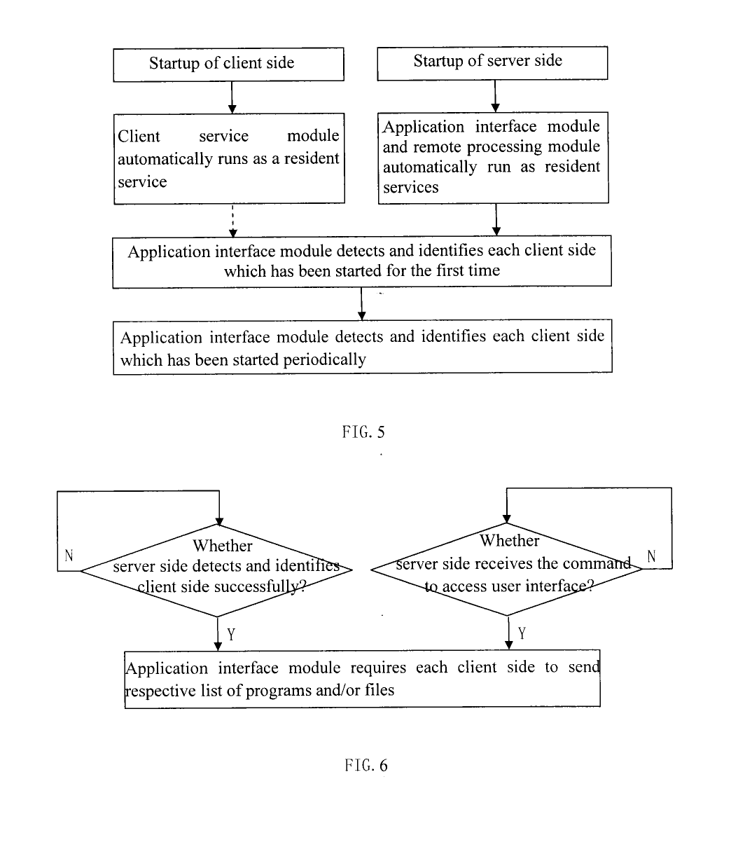

Please refer to FIG. 6, Once the server side detects and identifies the client side successfully, and/or once the remote processing module of the server side receives command to access the user interface from the remote control of the server side, said application interface module sends requests to each client side, each client side sends their lists of programs and/or files to the server side.

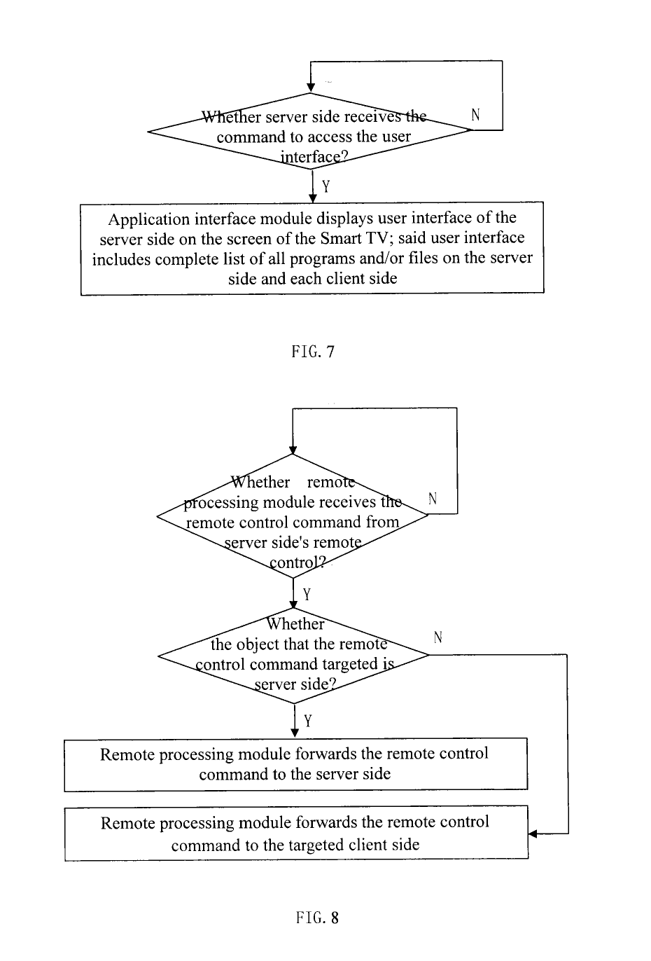

Please refer to FIG. 7, once the remote processing module of the server side receives command to access the user interface from the remote control of the server side, said application interface module displays the server side's user interface on the Smart TV's screen, said user interface includes complete lists of both server side's and all client sides' programs and/or files.

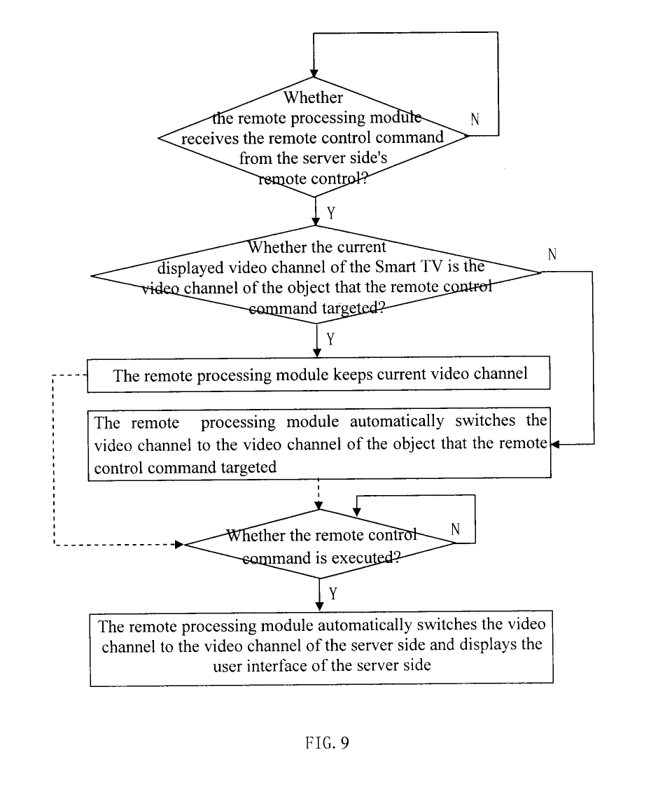

Please refer to FIG. 8, once the remote processing module of the server side receives the remote control command from server side's remote control, said remote processing module of server side distinguishes whether the object targeted by the remote control command is server side. If yes, the remote processing module forwards the remote control command to the server side. If not, the remote processing module forwards the remote control command to the client side which the remote control command targeted.

When the server side and the client side both support HDMI CEC protocol, and both sides are connected through the HDMI port then the remote control command can be forwarded by the CEC signal.

Please refer to FIG. 9, once the remote processing module of the server side receives the remote control command from server side's remote control, said remote processing module also distinguishes whether the Smart TV's current video channel is the video channel of the object which the remote control command targeted. If yes, then the remote processing module keeps the Smart TV's current video channel. If not, then the remote processing module automatically switches the Smart TV's video channel to the object which the remote control command targeted. Furthermore when the remote control command has been executed, said remote processing module automatically switches the Smart TV's video channel back to the server side and displays the server side's user interface. Furthermore, when the remote control command has been executed, such as current running program has exited, or current opening file has closed, said remote processing module automatically switches the Smart TV's video channel back to the server side and displays the server side's user interface.

When the server side and the client side both support HDMI CEC protocol, and both sides are connected through the HDMI port, then the video channel can be switched by CEC signal. However, if the Smart TV connects to multiple intelligent peripherals, the CEC signal can only support one intelligent peripheral automatically switching video channel. If it needs to operate another intelligent peripheral, the video channel needs to switch manually.

When the video channel between server side and client sides also transmits audio signal, then automatically switches the Smart TV's video channel including automatically switch the video signal and the audio signal. When there's independent audio channel between server side and client side, then said remote processing module also automatically switches the Smart TV's audio channel to the server side or client side which the remote control command targeted, and also automatically switches the Smart TV's audio channel back to the server side when the remote control command has been executed.

According to technical solution of the application, even if all intelligent devices do not support the HDMI CEC protocol, it will also bring the following benefits:

Firstly, there is only one user interface showed on the screen of the Smart TV by the server side , user does not need to switch multiple user interfaces of multiple intelligent devices. The user interface of the server side not only shows programs and/or files of the server side but also shows the programs and/or files of each client side.

Secondly, user operates programs and/or files in multiple intelligent devices by using one remote control (remote control of server side) and only aiming to the server side. The server side will distinguish the object that the remote control command targeted, and forwards the remote control command to the object which is targeted to process, and further carries out necessary command converting work in the course of forwarding.

Thirdly, when user faces to multiple intelligent devices, it is not required to switch the video channel manually. The server side will distinguish the object which the remote control command targeted and automatically switch to the corresponding video channel. When the operation is complete, the server side will also automatically switch to the video channel of the server side, and display the user interface of the server side.

Therefore, the application makes user operate the remote control of the server side only, and aim to the server side only to perform the remote operation, and see only one user interface, and not need to switch the video channel manually, thus it greatly facilitates user's operation. User cannot even feel that the programs and files are stored separately in different intelligent devices but thinks that all programs and files are stored in the server side.

Above is only preferable embodiments of the application but not intend to limit the application. For the skilled person of the technical field, the application may have various changes and variations. Any modification, equal alternation and improvement within the spirit and principle of the application shall be included in the scope of protection of the application.

1. An intelligent device which is either Smart TV or an intelligent peripheral connected to Smart TV, said intelligent device is used either as server side or as client side;
When said intelligent device is used as server side, it includes application interface module and remote processing module; said application interface module detects and identifies each client side directly or indirectly connected to the server side, and obtains lists of all client sides' programs and/or files, and displays the server side's user interface which includes lists of both server side's and all client sides' programs and/or files; said remote processing module receives the remote control command of server side's remote control, and forwards the remote control command to the server side or client side which the remote control command targeted, and automatically switches the Smart TV's video channel to the server side or client side which the remote control command targeted, and automatically switches the Smart TV's video channel back to the server side and displays the server side's user interface when the remote control command has been executed;
When said intelligent device is used as client side, it includes client service module; said client service module responds to the detection or identification process of the server side, and collects lists of client side's programs and/or files and sends to the server side by request, and receives server side's remote control command and converts to the client side's remote control key event.

2. The intelligent device according to claim 1, wherein said client side indirectly connected to the server side means: when the server side directly connects to the first client side, and the first client side directly connects to the second client side, then the server side indirectly connects to the second client side.

3. The intelligent device according to claim 1, wherein when the video channel between server side and client sides also transmits audio signal, then automatically switches the Smart TV's video channel including automatically switch the video signal and the audio signal; when there's independent audio channel between server side and client sides, then said remote processing module also automatically switches the Smart TV's audio channel to the server side or client side which the remote control command targeted, and also automatically switches the Smart TV's audio channel back to the server side when the remote control command has been executed.

4. An intelligent device control system which includes Smart TV and at least one intelligent peripheral connected to the Smart TV; one device of said Smart TV and intelligent peripherals is used as server side, while all other devices are used as client sides, there's transmission channel for video signal and command signal between Smart TV and each intelligent peripheral;
Said server side includes application interface module and remote processing module; said application interface module detects and identifies each client side directly or indirectly connected to the server side, and obtains lists of all client sides' programs and/or files, and displays the server side's user interface which includes lists of both server side's and all client sides' programs and/or files; said remote processing module receives the remote control command of server side's remote control, and forwards the remote control command to the server side or client side which the remote control command targeted, and automatically switches the Smart TV's video channel to the server side or client side which the remote control command targeted, and automatically switches the Smart TV's video channel back to the server side and displays the server side's user interface when the remote control command has been executed;
Said client side includes client service module; said client service module responds to the detection or identification process of the server side, and collects lists of the client side's programs and/or files and sends to the server side by request, and receives server side's remote control command and converts to the client side's remote control key event.

5. The intelligent device control system according to claim 4, wherein there's transmission channel for audio signal between Smart TV and each intelligent peripheral.

6. The intelligent device control system according to claim 4 , wherein the data transmission channel for all kinds of signal is the same physical interface, or the same wired or wireless data transmission way, or a combination of several different physical interfaces and/or several different data transmission way.

7. The intelligent device control system according to claim 4, wherein said Smart TV is used as server side, while all intelligent peripherals connected to the Smart TV are used as client sides;
Alternatively, said Smart TV is used as client side, one intelligent peripheral connected to the Smart TV is used as server side.

8. An implementation method of the intelligent device control system which comprising the following:
Once the server side detects and identifies the client side, and/or once the server side receives command to access the user interface, the application interface module of server side requests each client side to send their lists of programs and/or files to server side;
Once the server side receives command to access the user interface, the application interface module of server side displays the server side's user interface on the Smart TV's screen, said user interface includes complete lists of both server side's and all client sides' programs and/or files.

9. The implementation method of the intelligent device control system according to claim 8, wherein said method further comprising:
Once the server side receives the remote control command of server side's remote control, the remote processing module of server side distinguishes the object which the remote control command targeted, and forwards the remote control command to the object which the remote control command targeted; Meanwhile said remote processing module distinguishes if the Smart TV's video channel is the video channel of the object which the remote control command targeted; if yes, then the remote processing module keeps Smart TV's current video channel; if not, then the remote processing module automatically switches the Smart TV's video channel to the object which the remote control command targeted;
Further when the remote control command has been executed, said remote processing module automatically switches the Smart TV's video channel back to the server side and displays the server side's user interface.

10. The implementation method of the intelligent device control system according to claim 8, wherein said method further comprising:
Once the client side starts, built-in client service module will run automatically as a resident service; Once the server side starts, built-in application interface module and remote processing module will run automatically as resident services; After the server side's startup, the application interface module detects and identifies each client side which has been started, and periodically update the client sides.

11. The implementation method of the intelligent device control system according to claim 10, wherein when the server side is Smart TV, and client sides is intelligent peripheral connected to the Smart TV's HDMI port, then the server side detects and identifies each client side through the following method:
Step 1, the client side obtains physical address of server side's HDMI port through HDMI protocol;
Step 2, the server side searches client side which supports SSDP protocol through the SSDP protocol;
Step 3, the client side listens the inquiry message of SSDP protocol sent by the server side, if the inquiry message comforms to the specifications of SSDP protocol, the client side replies to the server side, the reply message includes its own IP address and the physical address of server side's HDMI port which the client side connected to;
Step 4, the server side indentifies the client side which connected to the HDMI port through the physical address of server side's HDMI port.

12. The implementation method of the intelligent device control system according to claim 9 , wherein when the server side and client sides both support HDMI CEC protocol, then the client side sends its own IP address to the server side through said protocol, therefore the server side detects and identifies the client side; And the client side forwards the remote control command and automatically switches Smart TV's video channel through said protocol.
